(19) United States
(12) Patent Application Publication
(10) Pub. No.: US 2022/0311042 A1
(43) Pub. Date: Sep. 29, 2022

(54) Battery Case

(71) Applicants: Hyundai Motor Company, Seoul (KR); Kia Corporation, Seoul (KR)

(72) Inventors: Kang Won Lee, Gyeonggi-do (KR); Hong Seok Min, Gyeonggi-do (KR); Byoung Cheon Jeong, Gyeonggi-do (KR); Ho Taek Lee, Seoul (KR); Yong Hwan Choi, Seoul (KR); Yu Ri Oh, Gyeonggi-do (KR)

(21) Appl. No.: 17/529,404

(22) Filed: Nov. 18, 2021

(30) Foreign Application Priority Data
Mar. 23, 2021 (KR) 10-2021-0037340

(51) Int. Cl. H01M 10/04; H01M 10/0525; H01M 50/289; H01M 50/204; H01M 50/249

(52) U.S. Cl. CPC H01M 10/0481; H01M 10/0525; H01M 50/289; H01M 50/204; H01M 50/249; H01M 2250/20

(57) ABSTRACT

A battery case includes an upper plate portion and a lower plate portion that are spaced apart from each other in vertical direction to form an inner space therebetween. Battery cells are stacked in the inner space in the vertical direction and a pressing portion is disposed in a first space between the upper plate portion and an uppermost one of the battery cells. The pressing portion presses the stacked battery cells downwards from above due to gravity. A damping portion is disposed in a second space between the upper plate portion and the upper surface of the pressing portion. The upper end of the damping portion is supported by the upper plate portion and the lower end of the damping portion supports the pressing portion.

### CROSS-REFERENCE TO RELATED APPLICATION

This application claims the benefit of Korean Patent Application No. 10-2021-0037340, filed on Mar. 23, 2021, the disclosure of which is herein incorporated by reference in its entirety.

### BACKGROUND OF THE DISCLOSURE

### 1. Field of the Disclosure

The present disclosure relates to a battery case that applies pressing force to stacked battery cells through a panel-shaped pressing portion and maintains the applied pressing force as uniform as possible through a damping portion, thereby reducing interface resistance between the battery cells and improving performance of the battery cells.

### 2. Description of the Related Art

With recent development of technology related to environmentally friendly vehicles, importance of technology related to batteries has further increased. In connection therewith, an all-solid-state battery, which uses a non-flammable inorganic-based solid electrolyte, has advantages in that the all-solid-state battery has a lower possibility of explosion and catching fire and is safer than a lithium ion battery, which uses an inflammable organic-based liquid electrolyte. In addition, the energy density of the all-solid-state battery may be increased through a bipolar structure, and the structure of the battery may be simplified, since there is no separator. The all-solid-state battery is being spotlighted as a next-generation battery due to the above advantages.

In the solid electrolyte of the all-solid-state battery, however, higher interface resistance may occur between an active material and the electrolyte than the liquid electrolyte. As a result, ion conductivity is lowered at the interface of an electrode, whereby output of the battery may be reduced and deterioration of the battery may be accelerated. Consequently, the all-solid-state battery requires higher pressing force than the lithium ion battery to reduce interface resistance.

However, a predetermined level or higher of pressing force may cause interface fracture of the battery and damage to a module structure. Pressure applied to a reduced thickness of the battery during discharging of the battery may be abruptly increased to a reference value or higher during charging of the battery, at which the thickness of the battery is increased. In the all-solid-state battery requiring high pressing force, therefore, it is necessary to design a pressing structure capable of preventing interface fracture of the battery and damage to a module structure during charging of the battery.

The matters disclosed in this section are merely for enhancement of understanding of the general background of the disclosure and should not be taken as an acknowledgment or any form of suggestion that the matters form the related art already known to a person skilled in the art.

### SUMMARY OF THE DISCLOSURE

The present disclosure has been made in view of the above problems, and it is an object of the present disclosure to provide a battery case capable of applying pressing force caused by the weight of a panel-shaped pressing portion to stacked battery cells downwards from above and maintaining the applied pressing force as uniform as possible through a damping portion, thereby reducing interface contact between the battery cells and improving performance of the battery cells.

In accordance with the present disclosure, the above and other objects may be accomplished by a battery case that may include an upper plate portion and a lower plate portion spaced apart from each other in an upward-downward direction to form an inner space therebetween, battery cells stacked in the inner space in the vertical direction, a pressing portion disposed in a first space between the upper plate portion and the uppermost one of the battery cells, the pressing portion configured to press the stacked battery cells downwards from above due to gravity, and a damping portion disposed in a second space between the upper plate portion and the upper surface of the pressing portion, the upper end of the damping portion being supported by the upper plate portion, the lower end of the damping portion configured to support the pressing portion.

A guide portion extending in the vertical direction to connect the upper plate portion and the lower plate portion to each other may be disposed between the upper plate portion and the lower plate portion, and the pressing portion may be configured to slide along the guide portion in the vertical direction. A plurality of guide portions may be provided at edges of the upper plate portion and the lower plate portion, and each guide portion may have a beam shape and support the upper plate portion and the lower plate portion.

A plurality of through-holes may be formed in the edge of the pressing portion, and each of the guide portions may be inserted through a corresponding one of the through holes, whereby the pressing portion slides along the guide portions in the vertical direction. The pressing portion may be configured to cover the upper surface of the uppermost battery cell, and surface pressure caused by the weight of the pressing portion may be applied to the upper surface of the uppermost battery cell, whereby the stacked battery cells may be pressed downwards from above.

The density or panel thickness of the pressing portion may be set based on required pressing force to be applied to the stacked battery cells, and pressing force based on the set density or panel thickness may be applied to the upper surface of the uppermost battery cell. The damping portion may be configured to absorb vibration or impact applied to the upper plate portion or the pressing portion to maintain the pressing force of the pressing portion when the pressing portion presses the battery cells.

The damping portion may be maintained compressed during charging of the battery cells and may be maintained uncompressed when the battery cells are used. The damping portion may number one or more and may be provided at a middle of each of the upper plate portion and the pressing portion or may be provided in plural to be symmetric with respect to the middle of each of the upper plate portion and the pressing portion. The damping portion may be coupled to the lower surface of the upper plate portion and the upper surface of the pressing portion by bolting, adhesion, or taping.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view showing a battery case according to an embodiment of the present disclosure;

FIG. 2 is an exploded perspective view showing the battery case according to the embodiment of the present disclosure;

FIG. 3 is an enlarged view showing a damping portion of the battery case according to the embodiment of the present disclosure; and

FIG. 4 is a view showing change in thickness of battery cells depending on charging and discharging of the battery case according to the embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

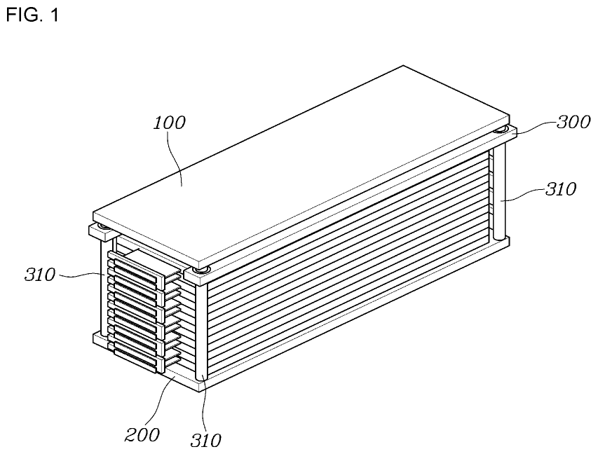

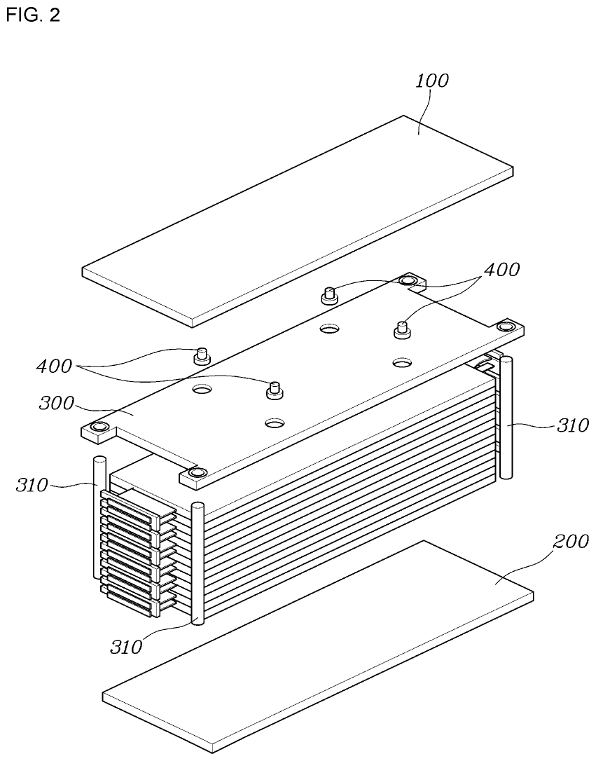

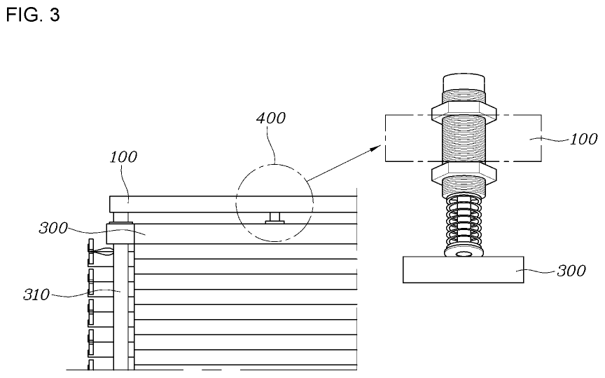

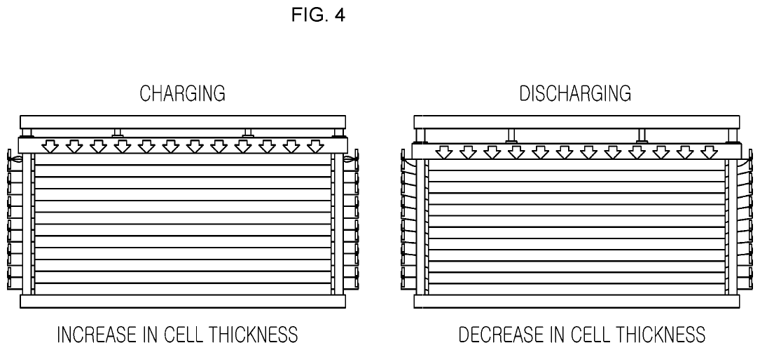

FIG. 1 is a view showing a battery case according to an embodiment of the present disclosure. FIG. 2 is an exploded perspective view showing the battery case according to the embodiment of the present disclosure. FIG. 3 is an enlarged view showing a damping unit of the battery case according to the embodiment of the present disclosure. FIG. 4 is a view showing change in thickness of battery cells depending on charging and discharging of the battery case according to the embodiment of the present disclosure.

FIG. 1 is a view showing a battery case according to an embodiment of the present disclosure. FIG. 2 is an exploded perspective view showing the battery case according to the embodiment of the present disclosure. The battery case according to the embodiment of the present disclosure may include an upper plate portion 100 and a lower plate portion 200 spaced apart from each other in an upward-downward direction to form an inner space therebetween, battery cells being stacked in the inner space in the upward-downward direction (e.g., vertical direction), a pressing portion 300 provided in a first space between the upper plate portion 100 and the uppermost battery cell, the pressing portion being configured to press the stacked battery cells downwards from above due to gravity, and a damping portion 400 disposed in a second space between the upper plate portion 100 and the upper surface of the pressing portion 300, the upper end of the damping portion being supported by the upper plate portion 100, the lower end of the damping portion being configured to support the pressing portion 300.

Specifically, in the battery case according to the embodiment of the present disclosure, high pressing force caused by the weight of the pressing portion 300 is applied to the battery cells, whereby contact resistance between an active material and a solid electrolyte of each of the all-solid-state battery cells is reduced. In addition, during charging and discharging or in the case in which vibration or impact occurs during driving, uniform pressing force is applied to the battery cells through the damping portion 400, whereby performance of a battery is improved and damage to the battery cells or the battery case is prevented.

Meanwhile, in the battery case according to the embodiment of the present disclosure, a guide portion 310 extending in the vertical direction to connect the upper plate portion 100 and the lower plate portion 200 to each other may be disposed between the upper plate portion 100 and the lower plate portion 200, and the pressing portion 300 may slide along the guide portion 310 in the vertical direction.

Specifically, a plurality of guide portions 310 may be provided at the edges of the upper plate portion 100 and the lower plate portion 200, and each guide portion 310, which has a beam shape, may support the upper plate portion 100 and the lower plate portion 200. In addition, a plurality of through-holes may be formed in the edge of the pressing portion 300. Each of the guide portions 310 may be inserted through a corresponding one of the through holes, whereby the pressing portion 300 may slide along the guide portions 310 in the vertical direction.

In other words, the guide portions 310 support the upper plate portion 100 and the lower plate portion 200 to form an inner space therebetween, and at the same time the pressing portion 300 may be coupled to the guide portions 310 to slide in the vertical direction. Consequently, pressing force caused by the weight of the pressing portion 300 is applied to the battery cells.

Meanwhile, in the battery case according to the embodiment of the present disclosure, the pressing portion 300 may cover the upper surface of the uppermost battery cell, and surface pressure caused by the weight of the pressing portion 300 is applied to the upper surface of the uppermost battery cell, whereby the stacked battery cells may be pressed downwards from above. The density or panel thickness of the pressing portion 300 may be set based on required pressing force to be applied to the stacked battery cells, and pressing force based on the set density or panel thickness may be applied to the upper surface of the uppermost battery cell.

Specifically, the pressing portion 200 comes into surface contact with the all-solid-state battery cell to apply uniform pressing force to the entire area of the all-solid-state battery cell. The all-solid-state battery cell requires higher load (about 3 MPa or higher) than a lithium ion battery. The density or thickness of a plate of the pressing portion 300 may be adjusted based on the size or type of the all-solid-state battery cell to apply sufficient pressing force. The pressing portion 300 may be made of an SUS material.

In addition, each of the upper plate portion 100 and the lower plate portion 200 may be made of a laser weldable material, such as Al or steel, and is coupled to the side wall of the battery case, which is also made of a laser weldable material, such as Al or steel, by laser welding. A beam made of a boltable material, such as Al or SUS, may be used as the guide portion 310, and ends of the guide portion may be bolted or otherwise fastened to the upper plate portion 100 and the lower plate portion 200.

FIG. 3 is an enlarged view showing the damping portion of the battery case according to the embodiment of the present disclosure. FIG. 4 is a view showing change in thickness of the battery cells depending on charging and discharging of the battery case according to the embodiment of the present disclosure. In the battery case according to the embodiment of the present disclosure, the damping portion 400 may absorb vibration or impact applied to the upper plate portion 100 or the pressing portion 300 to maintain the pressing force of the pressing portion 300 when the pressing portion presses the battery cells. In addition, the damping portion 400 may be maintained compressed during charging of the battery cells and may be maintained uncompressed when the battery cells are used.

Specifically, uniform pressing force may be applied to the battery cells, whereby contact resistance between the battery cells is reduced and the efficiency of the battery is improved. When the pressing force is too high or too low, however, the battery cells are damaged or contact resistance between the battery cells is not reduced. Accordingly, the damping portion 400 supports the upper plate portion 100 and the pressing portion 300 between the upper plate portion 100 and the pressing portion 300 and dampens vibration or impact applied to the upper plate portion 100 and the pressing portion 300 to uniformly maintain the pressing force of the pressing portion 300 applied to the battery cells.

In addition, since the cell thickness is increased when the battery cells are charged and the cell thickness is decreased when the battery cells are discharged, the damping portion 400 may be maintained compressed during charging and maintained uncompressed during discharging or driving, whereby uniform pressing force is maintained and abrupt change in pressing force is prevented.

Meanwhile, in the battery case according to the embodiment of the present disclosure, at least one damping portion 400 may be disposed at the middle of each of the upper plate portion 100 and the pressing portion 300, or a plurality of damping portions 400 may be disposed to be symmetric with respect to the middle of each of the upper plate portion 100 and the pressing portion 300. The damping portion 400 may be coupled to the lower surface of the upper plate portion 100 and the upper surface of the pressing portion 300 by bolting, adhesion, or taping.

The number and position of the damping portions 400 may be set depending on the level of vibration, impact, or load applied to the battery cells or the battery case and the specifications of a damper. For example, when the vibration, impact, or load applied to the battery cells or the battery case is high, high damping force of the damper is required, and therefore it is advantageous to provide a plurality of dampers. When the vibration, impact, or load applied to the battery cells or the battery case is low, low damping force of the damper is required, and therefore it is advantageous to provide a small number of dampers in consideration of cost and weight reduction. When a plurality of dampers are provided, however, the dampers must be disposed to be symmetric with respect to the middle of each of the upper plate portion 100 and the pressing portion 300, since the pressing portion 300 must apply uniform pressing force to the entire surface of the battery cells.

As is apparent from the above description, in a battery case according to the present disclosure, pressing force caused by the weight of a panel-shaped pressing portion is applied to stacked battery cells downwards from above, and the applied pressing force is maintained as uniform as possible through a damping portion, whereby interface contact between the battery cells is reduced and performance of the battery cells is improved.

Although the exemplary embodiments of the present disclosure have been described above with reference to the accompanying drawings, those skilled in the art will appreciate that the present disclosure may be implemented in various other embodiments without changing the technical ideas or features thereof.

What is claimed is:

1. A battery case, comprising:
an upper plate portion and a lower plate portion spaced apart from each other in a vertical direction to form an inner space therebetween, wherein battery cells are stacked in the inner space in the vertical direction;
a pressing portion disposed in a first space between the upper plate portion and an uppermost battery cell of the battery cells, wherein the pressing portion presses the stacked battery cells downwards from above due to gravity; and
a damping portion disposed in a second space between the upper plate portion and an upper surface of the pressing portion, wherein an upper end of the damping portion is supported by the upper plate portion, and a lower end of the damping portion supports the pressing portion.

2. The battery case according to claim 1, wherein a guide portion extending in the vertical direction to connect the upper plate portion and the lower plate portion to each other is disposed between the upper plate portion and the lower plate portion, and wherein the pressing portion slides along the guide portion in the vertical direction.

3. The battery case according to claim 2, wherein a plurality of guide portions are provided at edges of the upper plate portion and the lower plate portion, and each guide portion has a beam shape and supports the upper plate portion and the lower plate portion.

4. The battery case according to claim 3, wherein a plurality of through-holes is formed in an edge of the pressing portion, and each of the guide portions is inserted through a corresponding one of the through holes, and wherein the pressing portion slides along the guide portions in the vertical direction.

5. The battery case according to claim 1, wherein the pressing portion is configured to cover an upper surface of the uppermost battery cell, and surface pressure caused by a weight of the pressing portion is applied to the upper surface of the uppermost battery cell to press the stacked battery cells downwards from above.

6. The battery case according to claim 1, wherein a density or panel thickness of the pressing portion is set based on required pressing force to be applied to the stacked battery cells, and pressing force based on the set density or panel thickness is applied to an upper surface of the uppermost battery cell.

7. The battery case according to claim 1, wherein the damping portion is configured to absorb vibration or impact applied to the upper plate portion or the pressing portion to maintain the pressing force of the pressing portion when the pressing portion presses the battery cells.

8. The battery case according to claim 1, wherein the damping portion is maintained compressed during charging of the battery cells and is maintained uncompressed when the battery cells are used.

9. The battery case according to claim 1, wherein one or more damping portions are provided at a middle of each of the upper plate portion and the pressing portion or a plurality of damping portions are provided to be symmetric with respect to the middle of each of the upper plate portion and the pressing portion.

10. The battery case according to claim 1, wherein the damping portion is coupled to a lower surface of the upper plate portion and the upper surface of the pressing portion by bolting, adhesion, or taping.
